(19) United States
(12) Patent Application Publication
(10) Pub. No.: US 2020/0307644 A1
(43) Pub. Date: Oct. 1, 2020

(54) CONTROL SYSTEM FOR VEHICLE, NOTIFICATION METHOD FOR VEHICLE, AND MEDIUM

(71) Applicant: HONDA MOTOR CO., LTD., Tokyo (JP)

(72) Inventors: Akihiro HATTORI, Wako-shi (JP); Sadahiro YOKOYAMA, Wako-shi (JP); Keisuke ISHII, Wako-shi (JP)

(21) Appl. No.: 16/819,517

(22) Filed: Mar. 16, 2020

(30) Foreign Application Priority Data
Mar. 25, 2019 (JP) 2019-057025

(51) Int. Cl. B60W 60/00; B60W 50/16; B62D 15/02; B60W 40/08

(52) U.S. Cl. CPC B60W 60/0055; B60W 50/16; B60W 2040/0818; B60W 40/08; B62D 15/025

(57) ABSTRACT

A control system for a vehicle is provided. The system includes an automated driving control unit for performing driving control that is at least one of speed control and steering control of the vehicle, the control system comprises a detection unit configured to detect a state and an operation of an occupant, and a notification unit configured to notify the occupant of a change in what/who is to perform a driving operation, when travel control performed by the automated driving control unit is shifted to travel control performed according to manual driving, wherein the notification unit changes notification content stepwise in accordance with a change in at least one of the state and the operation of the occupant detected by the detection unit.

### CROSS-REFERENCE TO RELATED APPLICATION(S)

This application claims priority to and the benefit of Japanese Patent Application No. 2019-057025 filed on Mar. 25, 2019, the entire disclosure of which is incorporated herein by reference.

### BACKGROUND OF THE INVENTION

### Field of the Invention

The present invention relates to vehicle control technology. In particular, the present invention relates to a notification method for a vehicle.

### Description of the Related Art

In driver assistance control for a vehicle, a state where the vehicle controls travel is switched to a state where an occupant (driver) controls travel of the vehicle. When this switching occurs, the occupant is notified of a request for the switching. For example, International Publication No. 2018/105114 discloses that the notification method is appropriately switched in accordance with the state of the driver, giving consideration to the time remaining until automated driving is to be shifted to manual driving.

For example, in the control described in International Publication No. 2018/105114, if a driver is notified of a request for the driver to take over driving when the driver is relaxed while automated driving is performed, it is expected that driving will be affected due to the driver being flustered. For example, as a result of the driver being flustered, safety and stability during travel may be affected.

### SUMMARY OF THE INVENTION

The present invention enables an occupant to make a smooth shift when the occupant takes over driving.

The invention of the present application has the following configuration. That is to say, according to an aspect of the present invention, a control system for a vehicle is provided that includes an automated driving control unit for performing driving control that is at least one of speed control and steering control of the vehicle, the control system comprising: a detection unit configured to detect a state and an operation of an occupant; and a notification unit configured to notify the occupant of a change in what/who is to perform a driving operation, when travel control performed by the automated driving control unit is shifted to travel control performed according to manual driving, wherein the notification unit changes notification content stepwise in accordance with a change in at least one of the state and the operation of the occupant detected by the detection unit.

According to the present invention, an occupant can make a smooth shift when the occupant takes over driving.

### BRIEF DESCRIPTION OF THE DRAWINGS

FIG. 1 is a block diagram of a vehicle control apparatus according to an embodiment of the present invention.

FIG. 2 illustrates the state of a vehicle and a driver according to the embodiment of the present invention.

FIG. 3 schematically illustrates the summary of control according to the embodiment of the present invention.

FIG. 4 illustrates the relationship between a driver's operations and notifications according to the embodiment of the present invention.

FIG. 5 illustrates notification content and conditions for switching the notification according to the embodiment of the present invention.

FIGS. 6A and 6B show a flowchart of processing to control notification according to the embodiment of the present invention.

FIG. 7 is a flowchart of processing to generate alarm music according to the embodiment of the present invention.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### Vehicle Configuration

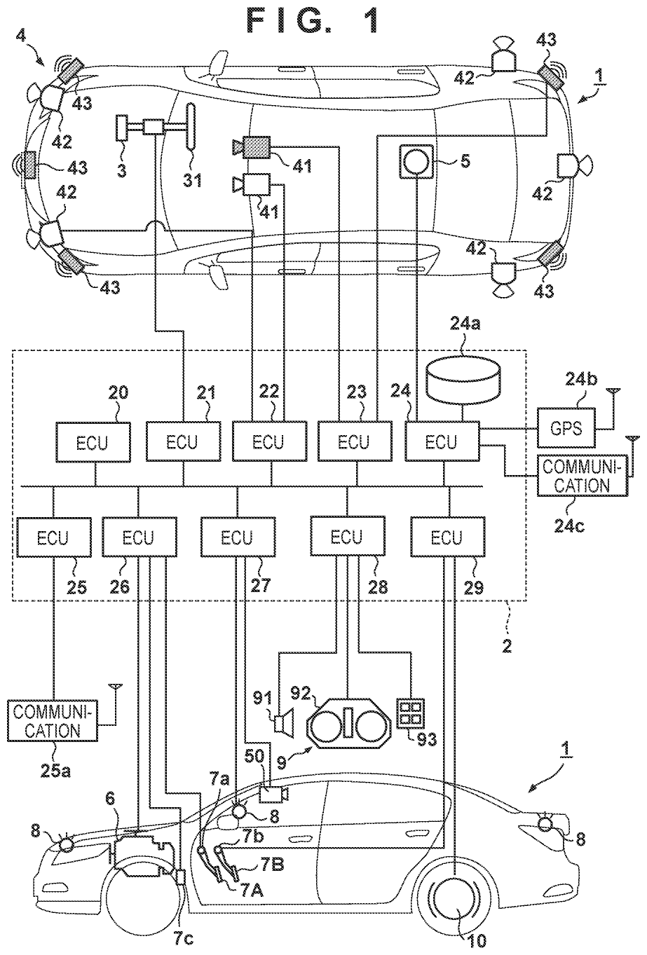

FIG. 1 is a block diagram of a vehicle control apparatus according to an embodiment of the present invention, and the vehicle control apparatus controls a vehicle 1. In FIG. 1, the vehicle 1 is schematically shown in a plan view and a side view. As an example, the vehicle 1 is a four-wheel drive passenger car of a sedan type.

The control apparatus in FIG. 1 includes a control system 2. The control system 2 includes a plurality of ECUs 20 to 29, which are communicably connected to each other via an in-vehicle network. Each of the ECUs functions as a computer that includes a processor, which is typified by a CPU, a storage device such as a semiconductor memory, an interface for an external device, and so on. Programs to be executed by the processor, data to be used in processing by the processor, and the like are stored in the storage device. Each of the ECUs may include a plurality of processors, storage devices, interfaces, and so on.

A description will be given below of functions and the like that are performed by the ECUs 20 to 29. Note that the number of ECUs and functions performed by the ECUs may be designed as appropriate, and the functions may be further segmented or integrated than in this embodiment.

The ECU 20 performs control associated with automated driving of the vehicle 1. In automated driving, at least either steering or acceleration/deceleration of the vehicle 1 is controlled automatically. In the later-described example control, both steering and acceleration/deceleration are controlled automatically.

The ECU 21 controls an electric power steering device 3. The electric power steering device 3 includes a mechanism for steering front wheels in accordance with a driving operation (steering operation) of a steering wheel 31 performed by a driver. The electric power steering device 3 also includes a motor that exerts a driving force for assisting the steering operation or automatically steering the front wheels, a sensor for detecting a steering angle, and so on. If the vehicle 1 is in an automated driving state, the ECU 21 automatically controls the electric power steering device 3 in accordance with instructions from the ECU 20, and controls the direction in which the vehicle 1 proceeds.

The ECUs 22 and 23 control detection units 41 to 43 for detecting the surroundings of the vehicle, and perform information processing on the detection results. The detection units 41 (which may also be referred to as cameras 41 below) are cameras for capturing images of an area in front of the vehicle 1, and in this embodiment, the detection units 41 are provided in a front portion of a roof of the vehicle 1, on a vehicle compartment side of a windshield. An outline of an object and a marking (white line etc.) of a traffic lane on a road can be extracted by analyzing the images captured by the cameras 41.

The detection units 42 (which may also be referred to as LIDARs 42 below) are Light Detection and Rangings (LIDARs), and detect an object in the surroundings of the vehicle 1 and measure the distance to an object. In this embodiment, five LIDARs 42 are provided, one is provided at each corner of the front part of the vehicle 1, one is provided at the center of the rear part, and one is provided on each side of the rear part. The detection units 43 (which may also be referred to as radars 43 below) are millimeter wave radars, and detect an object in the surroundings of the vehicle 1 and measure the distance to an object. In this embodiment, five radars 43 are provided, one is provided at the center in the front part of the vehicle 1, one is provided at each corner of the front part, and one is provided at each corner of the rear part.

The ECU 22 controls one of the cameras 41 and each of the LIDARs 42, and performs information processing on the detection results. The ECU 23 controls the other one of the cameras 41 and each of the radars 43, and performs information processing on the detection results. As a result of providing two sets of devices for detecting the surroundings of the vehicle, the detection results are more reliable. In addition, by providing different types of detection units, namely cameras, LIDARs, and radars, the surrounding environment of the vehicle can be analyzed in many aspects.

The ECU 24 controls a gyroscope sensor 5, a GPS sensor 24b, and a communication device 24c, and performs information processing on the detection results or communication results. The gyroscope sensor 5 detects rotational motion of the vehicle 1. The route of the vehicle 1 can be determined based on the detection results from the gyroscope sensor 5, wheel speed, and the like. The GPS sensor 24b detects the current position of the vehicle 1. The communication device 24c wirelessly communicates with a server that provides map information and traffic information, and acquires these kinds of information. The ECU 24 can access a database 24a of map information that is constructed in the storage device, and searches for a route from the current location to a destination, for example.

The ECU 25 includes a communication device 25a for inter-vehicle communication. The communication device 25a wirelessly communicates with other nearby vehicles and exchanges information between the vehicles.

The ECU 26 controls a powerplant 6. The powerplant 6 is a mechanism that outputs a driving force for rotating driving wheels of the vehicle 1, and includes an engine and a transmission, for example. The ECU 26 controls, for example, output of an engine in accordance with a driving operation (accelerator operation or acceleration operation) made by a driver that is detected by an operation detection sensor 7a, which is provided in an acceleration pedal 7A, and switches the gear ratio of the transmission based on information such as the vehicle speed that is detected by a vehicle speed sensor 7c. If the vehicle 1 is in an automated driving state, the ECU 26 automatically controls the powerplant 6 in accordance with instructions from the ECU 20 to control acceleration and deceleration of the vehicle 1.

The ECU 27 controls lighting devices (head light, tail light etc.) including direction indicators 8 (blinkers). In the example in FIG. 1, the direction indicators 8 are provided in the front part, door mirrors, and the rear part of the vehicle 1.

The ECU 28 controls an input/output device 9. The input/output device 9 outputs information to the driver, and accepts the input of information from the driver. A sound output device 91 notifies the driver of information using sound. The sound here may also include output other than a voice, such as music and a predetermined sound. A display device 92 notifies the driver of information by displaying an image. The display device 92 is disposed in front of a driver seat, for example, and constitutes an instrument panel or the like. Although sound and a display have been taken as an example here, the driver may alternatively be notified of information using a vibration, light, and/or air conditioning. Also, the user may be notified of information by combining two or more of sound, a display, a vibration, and light. Furthermore, different combinations may be employed or the mode of notification may be changed in accordance with the level (e.g. urgency) of information of which the driver is to be notified.

An input device 93 is a switch group that is disposed at a position at which the driver can operate the input device 93 and is used to give instructions to the vehicle 1, and may also include a sound input device.

The ECU 29 controls brake devices 10 and a parking brake (not shown). The brake devices 10, which are, for example, disc brake devices, are provided for the wheels of the vehicle 1, and decelerate or stop the vehicle 1 by applying resistance to the rotation of the wheels. For example, the ECU 29 controls operations of the brake devices 10 in accordance with a driving operation (braking operation) made by the driver that is detected by an operation detection sensor 7b, which is provided for a brake pedal 7B. If the vehicle 1 is in an automated driving state, the ECU 29 automatically controls the brake devices 10 in accordance with instructions from the ECU 20 to control deceleration and stoppage of the vehicle 1. The brake devices 10 and the parking brake can also operate to maintain a stopped state of the vehicle 1. If the transmission of the powerplant 6 has a parking lock mechanism, this mechanism can operate to maintain a stopped state of the vehicle 1.

The vehicle 1 further includes a vehicle interior detection unit 50 that detects the state of the interior of the vehicle. The vehicle interior detection unit 50 is constituted by a camera that serves as an image capture unit, a weight sensor, an orientation sensor, or the like, and is not specifically limited in terms of type. Note that the vehicle interior detection unit 50 may be provided for each of the seats provided in the vehicle 1, or may be a single component that is capable of viewing and monitoring the entire interior of the vehicle. Furthermore, means for detecting that operation portions of the vehicle 1 have been operated may be provided as the vehicle interior detection unit. For example, examples of the vehicle interior detection unit may include a touch sensor for detecting a gripped state of the steering wheel, a sensor for detecting that a seat belt has been fastened, and the like.

Example of Control Functions

Control functions of the vehicle 1 according to this embodiment include travel-related functions that are associated with control of driving, braking, and steering of the vehicle 1, and notification functions that are associated with notifying the driver of information. Note that each of the control functions may be provided with a plurality of control levels in accordance with performance or the like of the vehicle 1.

The travel-related functions may include, for example, control to maintain the vehicle speed, acceleration/deceleration timing control, control to keep to a traffic lane, control to suppress deviation from a traffic lane (control to suppress deviation from a road), control to change traffic lane, control to follow a forward vehicle, impact-reduction braking control, and control to suppress erroneous starts. The notification functions may include control to make an adjacent vehicle notification, control to make a forward-vehicle start notification, and control to make a driving request.

The control to maintain the vehicle speed is control for maintaining travel at a predetermined vehicle speed. For example, an acceleration pedal and a brake pedal are controlled to maintain the vehicle speed in accordance with a change in the shape of a road on which the vehicle is traveling or the external environment, for example. The acceleration/deceleration timing control is control for determining timing for acceleration and deceleration of the vehicle while giving consideration to the traveling state of the vehicle, switching to another operation, and the like. For example, these timings are controlled since, even if the same operation is performed, the timings of acceleration and deceleration may differ depending on the curvature of a curved road, the road shape, the traveling position, and the like.

The control to keep to a traffic lane is a kind of vehicle position control performed with respect to a traffic lane, and is control for causing the vehicle to travel, automatically (not according to an occupant's driving operation), on a traveling route that is set within a traffic lane. The control to suppress deviation from a traffic lane is a kind of vehicle position control performed with respect to a traffic lane, and is control to detect a white line or a median strip and automatically steer the vehicle so as not to go over a line. Thus, the control to suppress deviation from a traffic lane and the control to keep to a traffic lane are different functions.

The traffic lane change control is control for causing the vehicle to automatically move from the traffic lane in which the vehicle is traveling to an adjacent traffic lane. The control to follow a forward vehicle is control for automatically following another vehicle that is traveling in front of the self-vehicle. The impact-reduction braking control is control for automatically braking and assisting impact avoidance if the likelihood of the vehicle colliding with an obstacle in front of the vehicle has increased. The control to suppress erroneous starts is control for restricting acceleration of the vehicle if an accelerating operation made by the driver exceeds a predetermined amount or more when the vehicle is in a stopped state, thereby suppressing a sudden start.

The control to make an adjacent vehicle notification is control for notifying the driver of the presence of other vehicles traveling in a traffic lane that is adjacent to the traffic lane in which the self-vehicle is traveling, and for example, the driver is notified of the presence of other vehicles that are traveling on a side of the self-vehicle and rearward of the self-vehicle. The control to make a forward-vehicle start notification is control for notifying the driver that another vehicle in front of the self-vehicle has started when the self-vehicle and the other vehicle in front are in a stopped state. These notifications can be made by an in-vehicle notification device. The control to make a driving request notification refers to a notification for making a request for an operation relating to travel control to an occupant (driver). For example, a notification of a driving request is made when a state where the vehicle operation to travel is performed by the vehicle is to be switched to a state where the vehicle operation to travel is performed by the occupant (driver). Specific notification content here will be described later with reference to the drawings.

Summary of Operation

The summary of the vehicle and the driver according to this embodiment will be described. This embodiment will give a description while taking, as an example, a case where the driving status of the vehicle is shifted from a state where the occupant is not performing any operations at all and the vehicle 1 is performing control (hereinafter, “automated driving state”) to a state where the occupant (driver) (“manual driving state”) performs operations. Also, in this embodiment, a description will be given while assuming that the occupant (driver) is asleep immediately before the switching is performed.

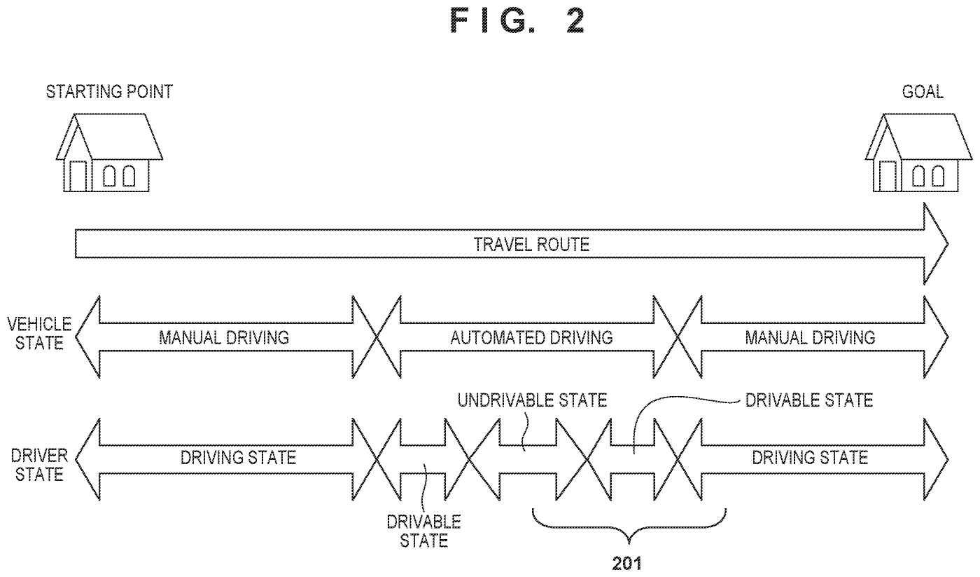

FIG. 2 illustrates the state of the vehicle and the driver according to this embodiment. A concept of switching of the vehicle state is illustrated. In this embodiment, a route from a starting point to a goal is set in advance. During travel on this route, the vehicle state is switched from manual driving to automated driving, and then to manual driving. The following description will be given assuming that the control according to this embodiment is performed at this time in an area 201. Note that, although FIG. 2 shows an example in which the vehicle state is switched twice, this need not be the case, and the vehicle state may be switched more.

The lower part of FIG. 2 shows the state of the driver. The “driving state” refers to a state where the driver is performing the driving operation of the vehicle 1. The “drivable state” refers to a state where, while automated driving is being performed, the driver can immediately perform the driving operation. Furthermore, the “undrivable state” refers to a state where the driver cannot immediately perform the driving operation because the driver is sleeping or relaxed. FIG. 2 shows an example in which the state of the driver transitions to the “undrivable state” once while automated driving is performed. The area 201 indicates the time before and after automated driving is switched to manual driving.

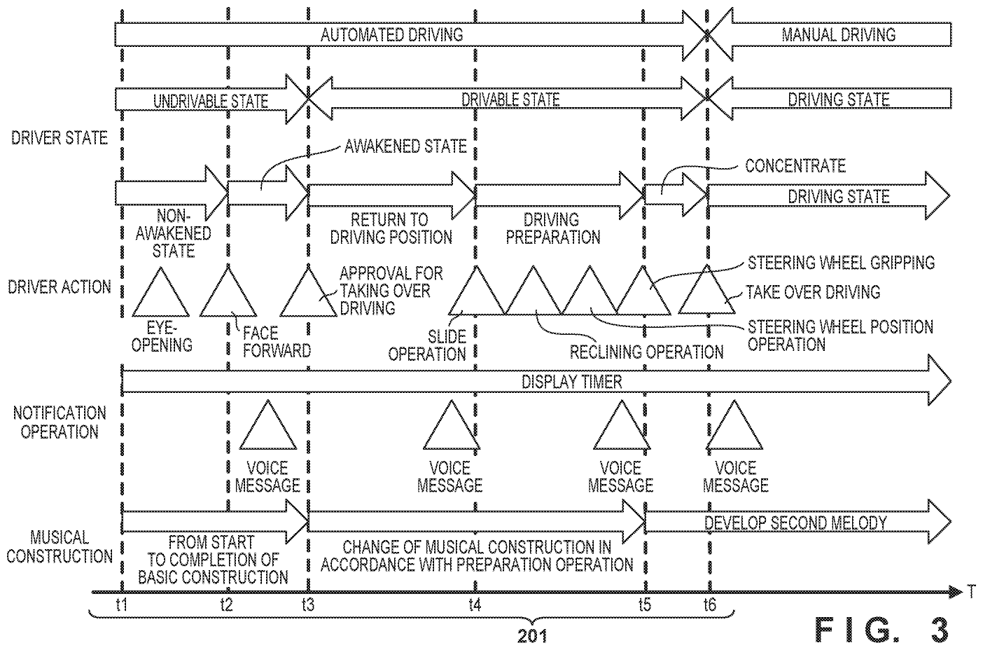

FIG. 3 illustrates the summary of the control according to this embodiment. Here, control performed in the area 201 shown in FIG. 2 is illustrated. A situation is assumed where, while autonomous driving is being performed based on a route setting or the like, a request to switch to manual driving is made due to the vehicle approaching the goal. In this example, a description will be given assuming that the driver has been sleeping during automated driving. Note that the state of the driver during automated driving is an example, and this need not be the case.

At a timing t1, the vehicle 1 detects that automated driving will end soon, and starts an operation to notify the driver of the need to take over driving. The notification operation according to this embodiment is performed by combining a timer display, a voice message, and output of music. The content of the timer display indicates the time limit for taking over of the driving operation. At this time, the display color and the display method may be gradually changed as the time limit approaches. The content of the voice message may also be gradually changed between the state of the driver, the content of the operation that the driver will be required to perform next, a message indicating that the time limit for manual driving is approaching, and the like.

At the timing t1, the vehicle 1 presents, on the timer, the time limit for taking over of driving. The timer is displayed on the display device 92, for example. The display content here may be a distance, or may be time. The vehicle 1 also starts outputting music (hereinafter referred to as “alarm music”), which is output for the purpose of starting manual driving. The details of a method of outputting the alarm music will be described later.

The vehicle 1 detects that the driver, who was asleep, has opened his/her eyes in response to the above notifications. The detection here is performed using the vehicle interior detection unit 50 that is provided in the vehicle 1 to grasp the situation in the vehicle. Thereafter, at a timing t2, the vehicle 1 detects that the line of sight of the driver has stabilized, and the driver is facing forward. Based on this detection, the vehicle 1 determines that the driver has transitioned from a non-awakened state to an awakened state (i.e. has woken up). Note that the state of the driver at this point is regarded as being the undrivable state, namely the state where the driver cannot immediately drive yet.

If the driver has entered the awakened state, the vehicle 1 notifies the driver of the request to switch to manual driving (request to take over driving) by means of sound (voice message). In response to the request, the vehicle 1 accepts an operation of the driver to approve the request to take over driving. The operation here may be performed by pressing a button that corresponds to approval for taking over driving, or may be performed by making a gesture or the like, for example. At this timing t3, the vehicle 1 determines that the driver has transitioned to the drivable state.

After the timing t3, the vehicle 1 changes the method of outputting the alarm music. The details of the output method here will be described later. From the timing t3 onward, the driver performs appropriate operations to perform the driving operation. The vehicle 1 detects these operations of the driver as appropriate. First, to perform the driving operation, the driver sits in the driver seat (returns to a driving position). At this time, for example, the vehicle 1 makes a notification to the driver (i.e. talks to the driver) to urge the driver to adjust his posture or the like in the driver seat. For example, the driver is notified of the seat position, the seat adjustment state such as a backrest adjustment state, or the like.

At a timing t4, the vehicle 1 detects a seat sliding operation of the driver seat. The vehicle 1 accordingly changes the method of outputting the alarm music. The detail of the output method here will be described later. Thereafter, the driver sequentially performs the backrest adjustment operation and the steering wheel positioning operation, and then grips the steering wheel. Note that the order of the operations at the timings t3 and t4 is an example, and this need not be the case.

At a timing t5, the vehicle 1 detects that the driver is gripping the steering wheel. The vehicle 1 accordingly changes the method of outputting the alarm music. The detail of the output method here will be described later. After a predetermined time period has elapsed, at a timing t6, automated driving is switched to manual driving. After automated driving has been switched to manual driving, the vehicle 1 notifies the driver of the switching to manual driving.

In FIG. 3, from the timing t1 to the timing t3, the operations to start outputting the alarm music and output the music while completing the basic musical construction thereof are performed sequentially. From the timing t3 to the timing t5, the driver's mood is excited toward manual driving, by changing the output of the alarm music in accordance with the driver's operations. From the timing t5 onward, alarm music corresponding to manual driving is output.

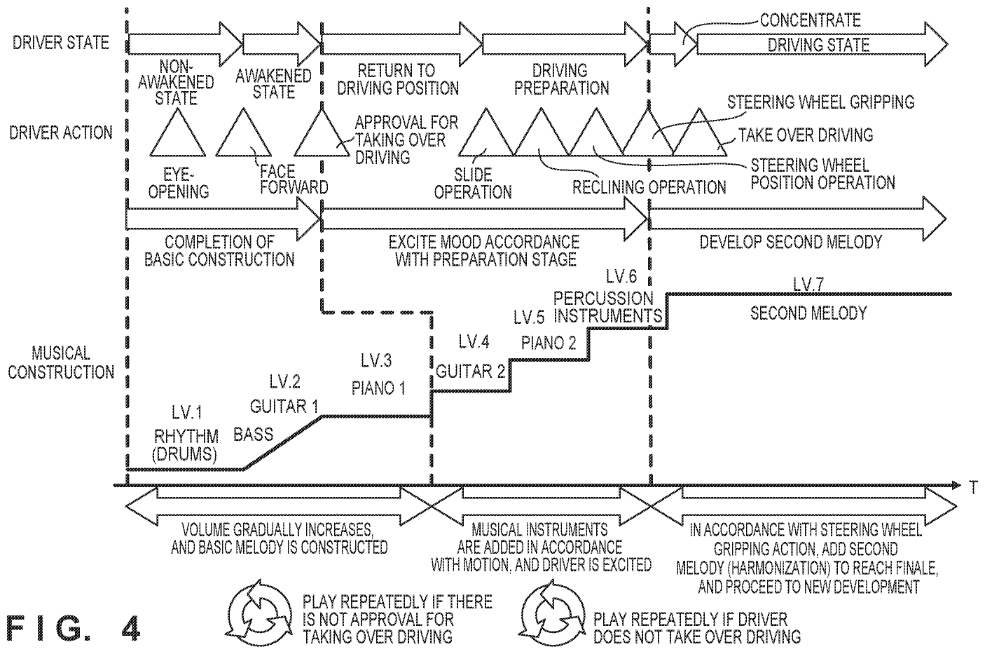

FIG. 4 illustrates the relationship between the driver's operations and notification content according to this embodiment. Note that FIG. 4 omits notifications using the timer and notifications made by a voice message.

The music (alarm music) used in this embodiment is constituted by the sound of a plurality of musical instruments. It is assumed here that the music is constituted by the sound of drums, a bass guitar, guitars (guitar 1 and guitar 2), pianos (piano 1 and piano 2), and percussion instruments. The alarm music is constructed as a so-called loop, and a predetermined one of a plurality of sections (bars) that constitute the alarm music can be repeated smoothly.

In this embodiment, a description will be given while assuming that 7 stages (level 1 to level 7) are used as stages when causing the driver to transition from the non-awakened state to the driving state. The output of sound that constructs the alarm music is varied in accordance with changes in the level. Level 1 to level 3 correspond to a period from the timing t1 to the timing t3 in FIG. 3. Transition from level 1 to level 3 is performed based on the state and operations of the occupant. If no change has been made in the state and operations of the occupant, the output of the alarm music is repeated at the same level. Level 4 to level 6 correspond to a period from the timing t3 to the timing t5 in FIG. 3. Transition from level 4 to level 6 is also performed based on the state and operations of the occupant. If no change has been made in the state and operations of the occupant, the output of the alarm music is repeated at the same level. Level 7 corresponds to a period from the timing t5 in FIG. 3.

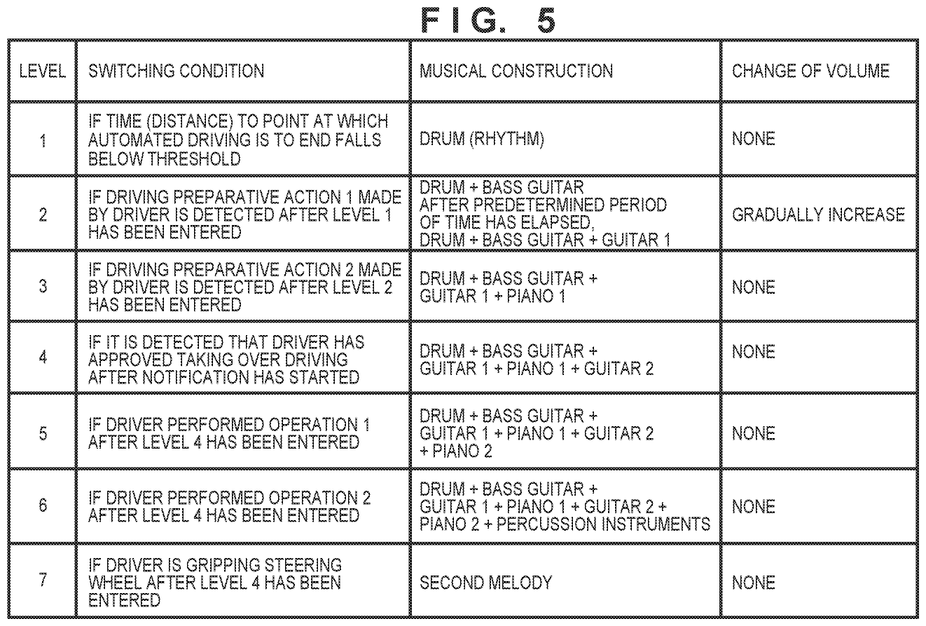

FIG. 5 shows the correspondence relationship between levels, conditions for switching the level, and musical construction of the alarm music according to this embodiment. As mentioned above, this embodiment will give a description using an example of seven stages. Also, in this embodiment, the number of musical instruments whose sounds constitute the alarm music increases as the level increases.

Level 1 is entered if, when automated driving is being performed, the time or the distance to be traveled until automated driving is to be ended falls below a predetermined threshold, based on the point in time of the end of automated driving. Note that the threshold here is determined in advance, and either the distance or time may be used as a reference. At level 1, only the sound of the drums (rhythm), of the sounds that constitute the alarm music, is output.

Level 2 is entered if, after level 1 has been entered, a driving preparative action 1 made by the driver is detected. The driving preparative action 1 here may be an action of opening his/her eyes (eye-opening) if the driver has been sleeping, for example. The detection here may be performed using, for example, an image acquired from an image capture device, which is the vehicle interior detection unit 50 provided in the vehicle 1. At level 2, the sounds of the drums (rhythm) and the bass guitar, of the sounds that constitute the alarm music, are output. After a predetermined time period has elapsed, the sound of the guitar 1 is also added. Also, at level 2, the volume gradually increases as time passes.

Level 3 is entered if, after level 2 has been entered, a driving preparative action 2 made by the driver is detected. The driving preparative action 2 here may be an action of facing forward of the vehicle 1 with respect to the traveling direction, for example. The detection here may be performed using, for example, an image acquired from the image capture device that is the vehicle interior detection unit 50 provided in the vehicle 1. At level 3, the sounds of the drums (rhythm), the bass guitar, the guitar 1, and the piano 1, of the sounds that constitute the alarm music, are output. Note that the driving preparative action 1 and the driving preparative action 2 may be a series of actions. Although, in the above example, the driver transitions from the sleeping state, this need not be the case, and for example, a series of operations to transition to the driving state from a state of performing other operations in the vehicle may be defined. A configuration may also be employed in which the above example and the aforementioned series of operations defined are combined to determine that the driver is in a state appropriate for driving (awakened state).

Level 4 is entered if, after the notification (at any level of level 1 to level 3) has started, it is detected that the driver has approved the request to take over driving. At level 4, the sounds of the drums (rhythm), the bass guitar, the guitar 1, the piano 1, and the guitar 2, of the sounds that constitute the alarm music, are output. At level 4, the basic construction (hereinafter, “first melody”) of the alarm music is completed.

Level 5 is entered if, after level 4 has been entered, it is detected that the driver has performed an operation 1. Examples of the operation 1 may include an operation to slide the driver seat. The detection here may be performed using, for example, a signal from a sensor that detects a seat position or the amount of change in the sliding of the seat after the driver seat in the vehicle 1 has been slid. At level 5, the sounds of the drums (rhythm), the bass guitar, the guitar 1, the piano 1, the guitar 2, and the piano 2, of the sounds that constitute the alarm music, are output.

Level 6 is entered if, after level 4 has been entered, it is detected that the driver has performed an operation 2. Examples of the operation 2 may include an operation to adjust the backrest of the driver seat. The detection here may be performed using, for example, a signal from a sensor that detects a seat position (orientation) or the amount of change in the adjustment of the backrest of the seat after the driver seat in the vehicle 1 has been adjusted. At level 6, the sounds of the drums (rhythm), the bass guitar, the guitar 1, the piano 1, the guitar 2, the piano 2, and the percussion instruments, of the sounds that constitute the alarm music, are output. At level 6, the sounds of the other musical instruments are added to the first melody, thereby exciting the driver's mood regarding the driving operation. Note that operations associated with the operation 1 and the operation 2 do not necessarily limit the order of the operations. For example, a configuration may be employed in which a plurality of operations are defined in advance, and when any of the defined operations is performed, processing is performed while regarding the operation performed first as the operation 1 and regarding the operation performed next as the operation 2. Accordingly, for example, the backrest adjustment operation may be performed after the seat sliding operation has been performed, or these operations may be performed in the reverse order.

Level 7 is entered if, after level 4 has been entered, it is detected that the driver is gripping the steering wheel. At level 7, of the sections that constitute the alarm music, a new section (hereinafter, “second melody”) that follows the section that has been output so far is output. The second melody may include a chord or the like, for example, in addition to the sounds of the seven aforementioned musical instruments.

The length of the section of the alarm music that is associated with each of the aforementioned levels may differ between the levels, or may be the same. That is to say, the length of the alarm music that is output in accordance with each of the levels may differ, or may be the same. Note that the level shifts not only at a timing at which the state or operations of the occupant is detected, and control may be performed such that the level switches at a break point at which the alarm music does not make the occupant feel uncomfortable, in the sections that constitute the alarm music.

Note that the above-described construction of the alarm music is an example, and this need not be the case. For example, the combination of musical instruments may be changed, and the number of levels to be switched may be changed. Also, the increase and decrease in the volume may be changed, and the order in which the musical instruments are inserted may be changed.

Also, other conditions may be employed as the conditions for switching the level. For example, a configuration may be employed in which transition to the awakened state of the driver is determined when level 2 is switched to level 3, or when the output is varied at level 2. The determination here is made based on an image acquired by a detection unit provided in the vehicle 1, for example. Specifically, the face of a person who is the driver is detected, and it is detected that the eyes of this person are open. Furthermore, it is detected that this person is awake, as a result of detecting that the person is facing forward. Note that the method for determining the awakened state of the person is not limited thereto, and the determination may be made using other criteria.

Processing Flow

### Notification Control

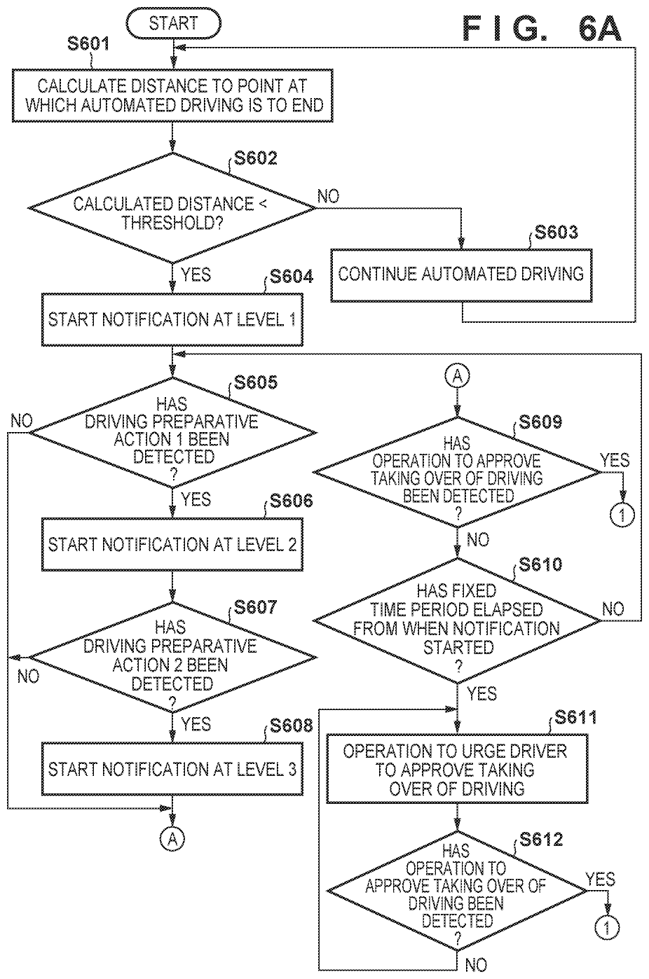

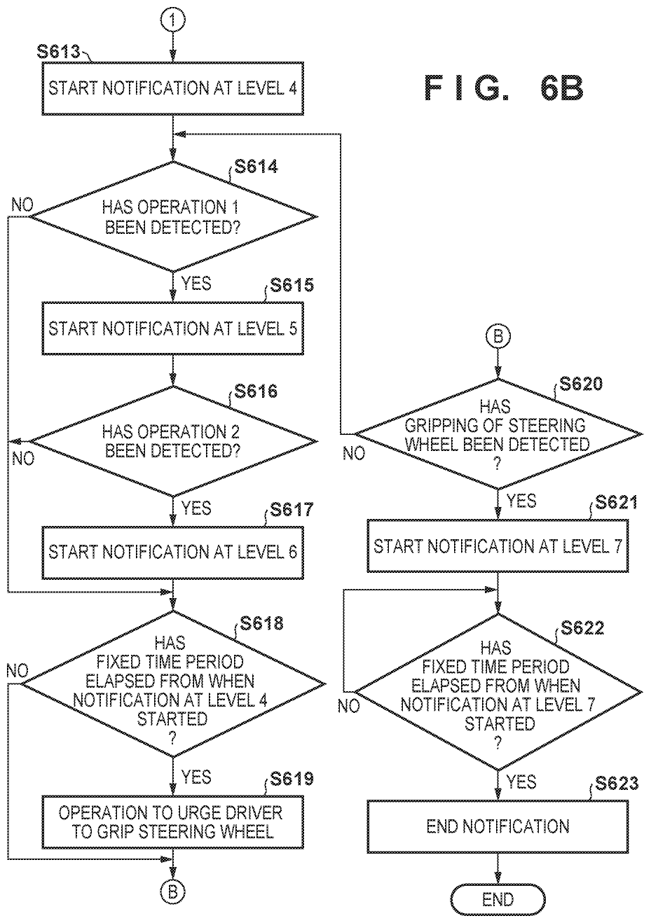

FIGS. 6A and 6B show a flowchart of processing to control notification according to this embodiment. In this processing flow, for example, the ECUs provided in the vehicle 1 perform processing in conjunction with each other, and here, to simplify the description, it is inclusively described that the processing is performed by the control system 2. The processing flow starts in parallel with automated driving when automated driving starts.

In step S601, the control system 2 acquires set route information, and specifies the position at which automated driving is to end. Furthermore, the control system 2 calculates the distance to the point at which automated driving is to be switched to manual driving, based on the current traveling state (speed, road condition, weather etc.). Although a description is given here while taking the distance as an example, the time required may be used in place of the distance, or both the distance and the time required may be used. Also, a predetermined area may be provided as a timing for switching from automated driving to manual driving. Accordingly, the distance to the point at which automated driving is to end may be calculated such that the driver can take over driving in this area.

In step S602, the control system 2 determines whether or not the distance calculated in step S601 falls below a predetermined threshold. The predetermined threshold here is defined in advance, and is stored in a storage area or the like. If it is determined that the calculated distance falls below the threshold (YES in S602), the processing proceeds to step S604, and if it is determined that the calculated distance does not fall below the threshold (NO in S602), the processing proceeds to step S603.

In step S603, the control system 2 continues the current automated driving. Then, the processing returns to step S601.

In step S604, the control system 2 starts the notification at level 1 using preset alarm music. It is assumed that, at this time, the alarm music has already been generated, and the notification content at each level has been defined.

In step S605, the control system 2 determines whether or not the driving preparative action 1 performed by the driver has been detected. Examples of the driving preparative action 1 here may include an eye-opening operation if the driver has been sleeping, but the driving preparative action 1 is not specifically limited. If the driving preparative action 1 has been detected (YES in S605), the processing proceeds to step S606, and if the driving preparative action 1 has not been detected (NO in S605), the processing proceeds to step S609 while continuing the notification at level 1.

In step S606, the control system 2 starts the notification at level 2 using the preset alarm music. When level 1 is switched to level 2, the music changes in a manner that is natural to the driver. Note that, at level 2, for example, the volume is varied as time passes, and the type of sound of the musical instruments that constitute the alarm music is increased, as described with reference to FIG. 5.

In step S607, the control system 2 determines whether or not the driving preparative action 2 performed by the driver has been detected. Examples of the driving preparative action 2 here may include an action of facing forward of the vehicle 1 with respect to the traveling direction, as an action performed after the driving preparative action 1 (eye-opening) has been performed in the case where the driver was sleeping, but the driving preparative action 2 is not specifically limited. A configuration may also be employed in which, for example, a plurality of combinations of actions are defined, in advance, as the driving preparative actions, in association with the state of the driver, and when this processing flow is started, it is decided which of the defined actions are to be used to make the determination. If the driving preparative action 2 has been detected (YES in S607), the processing proceeds to step S608, and if the driving preparative action 2 has not been detected (NO in S607), the processing proceeds to step S609 while continuing the notification at level 2.

In step S608, the control system 2 starts the notification at level 3 using the preset alarm music. When level 2 is shifted to level 3, the music changes in a manner that is natural to the driver.

In step S609, the control system 2 determines whether or not an operation to approve taking over of driving performed by the driver has been detected. If it is determined that an operation to approve taking over of driving performed by the driver has been detected (YES in S609), the processing proceeds to step S613. If it is determined that an operation to approve taking over of driving performed by the driver has not been detected (NO in S609), the processing proceeds to step S610.

In step S610, the control system 2 determines whether or not a fixed time period A has elapsed from when the notification at level 1 started. The fixed time period A here is associated with a timing in the alarm music, for example. This timing may be determined by performing an inverse operation using the aforementioned break point, while giving consideration to an appropriate break point in the music when level 4 is entered, or may be determined by performing an inverse operation using the timing at which automated driving is to end. If it is determined that the fixed time period A has elapsed (YES in S610), the processing proceeds to step S611, and if is determined that the fixed time period A has not elapsed (NO in S610), the processing returns to step S605 while continuing the notification at the current level. Note that, in this embodiment, if the processing returns to step S605, the level is not shifted to a lower level, but is shifted to an upper level in accordance with detection of operations.

In step S611, the control system 2 performs an operation to urge the driver to approve taking over of driving. Examples of the urging operation here may include, for example, increasing the volume of the alarm music that is currently output, and urging the driver to perform an operation to approve taking over of driving, using a screen display on the display device 92 or sound output by the sound output device 91. In addition, the seat belt of the driver seat on which the driver is seated may be vibrated, and the lighting in the vehicle may be adjusted. The driver's attention may be thus brought to driving (approval for taking over driving).

In step S612, the control system 2 determines whether or not an operation to approve taking over of driving performed by the driver has been detected. If it is determined that an operation to approve taking over of driving performed by the driver has been detected (YES in S612), the processing proceeds to step S613. If it is determined that an operation to approve taking over of driving performed by the driver has not been detected (NO in S612), the processing returns to step S611, and the urging operation is performed again. If the urging operation is performed again, an urging operation with content different from the previously-performed urging operation may be performed. For example, a configuration may be employed in which the volume of the alarm music is increased in the first urging operation, and information that urges the driver to approve taking over of driving is presented by the display device 92 in the second urging operation.

In step S613, the control system 2 starts the notification at level 4 using the preset alarm music. When level 3 is shifted to level 4, the music changes in a manner that is natural to the driver.

In step S614, the control system 2 determines whether or not it has been detected that the operation 1 was performed by the driver. Examples of the operation 1 may include an operation to slide the driver seat. If the operation 1 has been detected (YES in S614), the processing proceeds to step S615, and if the operation 1 has not been detected (NO in S614), the processing proceeds to step S618.

In step S615, the control system 2 starts the notification at level 5 using the preset alarm music. When level 4 is shifted to level 5, the music changes in a manner that is natural to the driver.

In step S616, the control system 2 determines whether or not it has been detected that the operation 2 was performed by the driver. Examples of the operation 2 may include an operation to adjust the backrest of the driver seat. If the operation 2 has been detected (YES in S616), the processing proceeds to step S617, and if the operation 2 has not been detected (NO in S616), the processing proceeds to step S618.

In step S617, the control system 2 starts the notification at level 6 using the preset alarm music. When level 5 is shifted to level 6, the music changes in a manner that is natural to the driver.

In step S618, the control system 2 determines whether or not a fixed time period B has elapsed from when the notification at the level 4 started. The fixed time period B here is associated with a timing in the alarm music, for example. This timing may be determined by performing an inverse operation using the aforementioned break point, while giving consideration to an appropriate break point in the music when the level switches to level 7, or may be determined by performing an inverse operation using the timing at which automated driving is to end. If it is determined that the fixed time period B has elapsed (YES in S618), the processing proceeds to step S619. On the other hand, if it is determined that the fixed time period B has not elapsed (NO in S618), the processing proceeds to step S620. If the operation 1 has not been detected by this point of continuation determination, it means that the notification at level 4 is currently being performed. Thus, the notification at level 4 is continued. If the operation 2 has not been detected by this point of continuation determination here, it means that the notification at level 5 is currently being performed. Thus, the notification at level 5 is continued.

In step S619, the control system 2 performs an operation to urge the driver to grip the steering wheel. Examples of the urging operation here may include increasing the volume of the alarm music that is currently being output, and urging the driver to grip the steering wheel using a screen display or sound. In addition, the seat belt of the driver seat on which the driver is seated may be vibrated, and the lighting in the vehicle may be adjusted. The driver's attention may thus be brought to driving (gripping of the steering wheel). In the urging operation here, a plurality of operations may be performed stepwise, or may be performed simultaneously.

In step S620, the control system 2 determines whether or not gripping of the steering wheel by the driver has been detected. The determination here may be made based on an image acquired by an image capture device that is the vehicle interior detection unit 50 provided in the vehicle 1, or may be made based on the output of a touch sensor provided in the steering wheel. If it is determined that gripping of the steering wheel has been detected (YES in S620), the processing proceeds to step S621, and if it is determined that gripping of the steering wheel has not been detected (NO in S620), the processing proceeds to step S614. Note that, in this embodiment, if the processing returns to step S614, the level is not shifted to a lower level, but is shifted to an upper level in accordance with detection of operations. If, after the processing has returned to step S614, the urging operation is performed again in step S619, an urging operation with content different from the previously-performed urging operation may be performed. For example, a configuration may be employed in which the volume of the alarm music is increased in the first urging operation, and the seat belt is vibrated in the second urging operation.

In step S621, the control system 2 starts the notification at level 7 using the preset alarm music. When the level is shifted here, the music changes in a manner that is natural to the driver. Also, at this time, control is performed such that automated driving is switched to manual driving at a timing at which a predetermined range of the music at level 7 is output. That is to say, the driver's mood is excited encouraging him or her to drive as a result of control being performed such that manual driving is started by the driver when the alarm music is most lively (e.g. when a hook of the music is played).

In step S622, the control system 2 determines whether or not a fixed time period C has elapsed from when the notification at the level 7 started. The fixed time period C corresponds to the length of the music associated with level 7. If it is determined that the fixed time period C has elapsed (YES in S622), the processing proceeds to step S623, and if it is determined that the fixed time period C has not elapsed (NO in S622), the notification at level 7 is continued.

In step S623, the control system 2 ends the notification. Then, the control system 2 ends this processing flow. Note that although, in this configuration, the notification ends when the fixed time C has elapsed, this need not be the case, and a configuration may alternatively be employed in which the notification shifts to music different from the alarm music, for example.

With the above configuration, an occupant can make a smooth shift when the occupant takes over driving.

Music Generation Processing

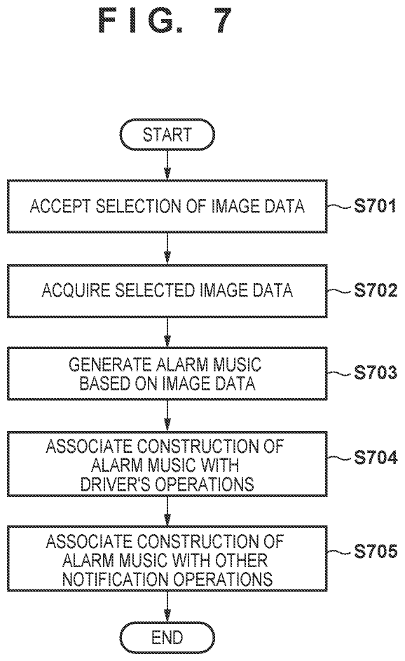

FIG. 7 is a flowchart of processing to generate alarm music according to this embodiment. This processing flow is carried out by an information processor (not shown). The information processor here may be an ECU provided in the vehicle 1, or may be an information processor other than that provided in the vehicle 1. For example, a configuration may be employed in which a corresponding application program is executed in a PC (Personal Computer) or the like owned by the driver. Alternatively, a configuration may be employed in which the processing flow is carried out in a server that is connected to the vehicle 1 via a network (not shown).

In step S701, the information processor accepts the user's selection of image data. Here, a configuration may be employed in which the information processor provides a UI (User Interface) for inputting image data, and the user inputs image data to this UI or designates candidate image data presented on the UI. At this time, settings related to the basic construction of music, user's preferences, and the like that are to be used to generate alarm music may also be accepted.

In step S702, the information processor acquires image data selected in step S701.

In step S703, the information processor generates alarm music based on the image data acquired in step S702. The method for generating music data based on image data is not specifically limited, and may be a known method. At this time, the alarm music is constructed so as to be provided with defined levels (levels 1 to 7 in the above example), and is also constructed so as to be able to be played repeatedly.

In step S704, the information processor associates the construction of the alarm music generated in step S703 with driver's operations performed when automated driving is switched to manual driving. Specifically, the timings of switching the alarm music are associated with the driver's operations, in correspondence with the switching conditions shown in FIG. 5. Note that a configuration may be employed in which the switching conditions, designation of driver's operations that are to be used as the conditions, and the like are accepted from the user.

In step S705, the information processor associates the construction of the alarm music generated in step S703 with other notification operations performed when automated driving is switched to manual driving. Examples of the other notification operations here may include a timer display, a voice message using audio, and the like, as mentioned above. The designation here may be accepted individually from the user. Then, the processing flow ends.

In the above example, alarm music is generated based on image data provided by the user, but this need not be the case. For example, some pieces of alarm music may be prepared in advance, and the user may select one of these pieces of alarm music. A configuration may also be employed in which alarm music is generated based on other original data.

The above processing need not be performed for each piece of image data, and may be collectively performed for a plurality of pieces of image data. One piece of alarm music may be generated based on one piece of image data, or one piece of alarm music may be generated based on a plurality of pieces of image data. Also, a configuration may be employed in which alarm music that has been generated once is modulated or arranged according to user preference.

As described above, this embodiment allows an occupant to make a comfortable and smooth shift when autonomous driving is switched to manual driving.

### Other Embodiments

The above embodiment has described an example that uses alarm music, a timer, and a voice message as notification methods. However, this need not be the case, and for example, air-conditioning, lighting, vibration, or the like may also be combined. Regarding this, the air flow, the lighting color, and the amount of light may be adjusted in accordance with the output state of the alarm music. Also, for example, a combination of engine sound, narration, and a tone of voice may be used in place of alarm music.

As for the content of a voice message as well, the tone of voice and the message speed, as well as the content of the request, may be varied in accordance with the level.

### Summary of Embodiment

1. A control system for a vehicle according to the above embodiment is a control system (e.g. 2) for a vehicle (e.g. 1) that includes an automated driving control unit for performing driving control that is at least one of speed control and steering control of the vehicle, the control system including:

a detection unit (e.g. 2, 50) configured to detect a state and an operation of an occupant; and

a notification unit (e.g. 2, 91) configured to notify the occupant of a change in what/who is to perform a driving operation, when travel control performed by the automated driving control unit is shifted to travel control performed according to manual driving, wherein the notification unit changes notification content stepwise in accordance with a change in at least one of the state and the operation of the occupant detected by the detection unit.

According to this embodiment, an occupant can make a smooth shift when the occupant takes over driving.

2. In the above embodiment, the detection unit detects an awakened state of the occupant.

According to this embodiment, the notification content can be switched stepwise in accordance with the awakened state of the occupant.

3. In the above embodiment, the detection unit detects an operation of the occupant performed on a seat.

According to this embodiment, the notification content can be switched stepwise in accordance with an operation of the occupant performed on the seat.

4. In the above embodiment, the detection unit detects gripping of a steering wheel by the occupant.

According to this embodiment, the notification content can be switched stepwise in accordance with the occupant gripping the steering wheel.

5. In the above embodiment, the detection unit detects an operation of the occupant to approve the change in what/who is to perform the driving operation.

According to this embodiment, the notification content can be switched stepwise in accordance with the operation of the occupant to approve switching to manual driving.

6. In the above embodiment, the notification unit makes a notification using music, and

the notification unit increases, stepwise, the number of musical instruments used in a construction of the music, in accordance with the change in at least one of the state and the operation of the occupant detected by the detection unit.

According to this embodiment, the occupant can make a smooth shift in accordance with the music when the occupant takes over driving.

7. In the above embodiment, the music is constructed as a loop, and

if no change is detected in at least one of the state and the operation of the occupant, the notification unit repeatedly outputs a predetermined range of the music.

According to this embodiment, the music can be output in accordance with whether or not the state and/or the operation of the occupant has changed.

8. In the above embodiment, if a change is detected in at least one of the state and the operation of the occupant, the notification unit does not change the construction of the music until output of a break point of the music output at a point in time of the detection ends.

According to this embodiment, when the music used as the notification is output, the notification can be made without making the occupant feel uncomfortable.

9. In the above embodiment, the notification unit performs control so as to output a predetermined range of the music at a timing at which the travel control performed by the automated driving control unit is shifted to the travel control performed according to the manual driving.

According to this embodiment, the occupant's mood can be uplifted encouraging him or her to drive when manual driving is to be performed by the occupant.

10. In the above embodiment, the notification unit makes a notification using any of a timer display, sound, air-conditioning, adjustment of a seat belt, vibration, and lighting.

According to this embodiment, notification for manual driving can be made stepwise using a timer display, sound, air-conditioning, adjustment of the seat belt, vibration, and lighting.

11. A notification method for a vehicle (e.g. 1) that includes an automated driving control unit for performing driving control that is at least one of speed control and steering control of the vehicle, the method including:

detecting a state and an operation of an occupant by a detection unit (e.g. 2); and

notifying the occupant of a change in what/who is to perform a driving operation, when travel control performed by the automated driving control unit is shifted to travel control performed according to manual driving,

wherein, during the notifying, notification content is changed stepwise in accordance with a change in at least one of the state and the operation of the occupant detected by the detection unit.

According to this embodiment, an occupant can make a smooth shift when the occupant takes over driving.

12. A non-transitory computer-readable medium including a program stored therein, the program, upon being executed by a computer (e.g. 2) provided in a vehicle (e.g. 1) that includes an automated driving control unit for performing driving control that is at least one of speed control and steering control of the vehicle, causing the computer to:

detect a state and an operation of an occupant using a detection unit; and

notify the occupant of a change in what/who is to perform a driving operation, when travel control performed by the automated driving control unit is shifted to travel control performed according to manual driving,

wherein, during the notifying, notification content is changed stepwise in accordance with a change in at least one of the state and the operation of the occupant detected by the detection unit.

According to this embodiment, an occupant can make a smooth shift when the occupant takes over driving.

The invention is not limited to the foregoing embodiments, and various variations/changes are possible within the spirit of the invention.

What is claimed is:

1. A control system for a vehicle that includes an automated driving control unit for performing driving control that is at least one of speed control and steering control of the vehicle, the control system comprising:
a detection unit configured to detect a state and an operation of an occupant; and
a notification unit configured to notify the occupant of a change in what/who is to perform a driving operation, when travel control performed by the automated driving control unit is shifted to travel control performed according to manual driving,
wherein the notification unit changes notification content stepwise in accordance with a change in at least one of the state and the operation of the occupant detected by the detection unit.

2. The control system according to claim 1,
wherein the detection unit detects an awakened state of the occupant.

3. The control system according to claim 1,
wherein the detection unit detects an operation of the occupant performed on a seat.

4. The control system according to claim 1,
wherein the detection unit detects gripping of a steering wheel by the occupant.

5. The control system according to claim 1,
wherein the detection unit detects an operation of the occupant to approve the change in what/who is to perform the driving operation.

6. The control system according to claim 1,
wherein the notification unit makes a notification using music, and
the notification unit increases, stepwise, the number of musical instruments used in a construction of the music, in accordance with the change in at least one of the state and the operation of the occupant detected by the detection unit.

7. The control system according to claim 6,
wherein the music is constructed as a loop, and
if no change is detected in at least one of the state and the operation of the occupant, the notification unit repeatedly outputs a predetermined range of the music.

8. The control system according to claim 6,
wherein, if a change is detected in at least one of the state and the operation of the occupant, the notification unit does not change the construction of the music until output of a break point of the music output at a point in time of the detection ends.

9. The control system according to claim 6,
wherein the notification unit performs control so as to output a predetermined range of the music at a timing at which the travel control performed by the automated driving control unit is shifted to the travel control performed according to the manual driving.

10. The control system according to claim 1,
wherein the notification unit makes a notification using any of a timer display, sound, air-conditioning, adjustment of a seat belt, vibration, and lighting.

11. A notification method for a vehicle that includes an automated driving control unit for performing driving control that is at least one of speed control and steering control of the vehicle, the method comprising:
detecting a state and an operation of an occupant by a detection unit; and
notifying the occupant of a change in what/who is to perform a driving operation, when travel control performed by the automated driving control unit is shifted to travel control performed according to manual driving,
wherein, during the notifying, notification content is changed stepwise in accordance with a change in at least one of the state and the operation of the occupant detected by the detection unit.

12. A non-transitory computer-readable medium including a program stored therein, the program, upon being executed by a computer provided in a vehicle that includes an automated driving control unit for performing driving control that is at least one of speed control and steering control of the vehicle, causing the computer to:
detect a state and an operation of an occupant using a detection unit; and
notify the occupant of a change in what/who is to perform a driving operation, when travel control performed by the automated driving control unit is shifted to travel control performed according to manual driving,
wherein, during the notifying, notification content is changed stepwise in accordance with a change in at least one of the state and the operation of the occupant detected by the detection unit.
